(19) United States
(12) Patent Application Publication
(10) Pub. No.: US 2005/0105402 A1
(43) Pub. Date: May 19, 2005

(54) Magneto-optical head and magneto-optical disk drive

(75) Inventors: Goro Kawasaki, Kawasaki (JP); Tsuyoshi Matsumoto, Kawasaki (JP); Hiroyasu Yoshikawa, Kawasaki (JP); Nobuyuki Kanto, Kawasaki (JP)

Correspondence Address: Patrick G. Burns, Esq.;GREER, BURNS, & CRAIN, LTD., Suite 2500, 300 South Wacker Dr., Chicago, IL, 60606, US

(73) Assignee: FUJITSU LIMITED

(21) Appl. No.: 10/845,896

(22) Filed: May 14, 2004

(30) Foreign Application Priority Data
Nov. 19, 2003 (JP) 2003-389076

(51) Int. Cl. G11B 11/00

(52) U.S. Cl. 369/13.02

(57) ABSTRACT

A magneto-optical head includes a focus lens for forming a light spot on a disk, a magnetic field generation coil arranged between the lens and the disk, and a heat conductor for conducting heat generated at the coil. The heat conductor is connected to a winding of the coil and extending radially outward from the coil.

### BACKGROUND OF THE INVENTION

1. Field of the Invention

The present invention relates to a magneto-optical head for writing data to and reading data from a magneto-optical disk. The invention also relates to a magneto-optical disk drive provided with such a magneto-optical head.

2. Description of the Related Art

JP-A-2003-51144, for example, discloses a magneto-optical head used for recording data by magnetic field modulation. The disclosed magneto-optical head includes an optical lens for forming a light spot on a data storage disk, a coil arranged between the lens and the disk for generating a magnetic field, and a magnetic element arranged between the coil and the lens. The coil generates heat when a current flows through the coil. For dissipating the heat, the magneto-optical head is provided with a heat sink surrounding the coil. When the disk rotates, airflow is caused between the disk and the MO head, which contributes to the cooling of the heat sink.

However, the above-described prior art structure cannot provide sufficient heat dissipation effect because of the following reasons.

In the magnetic field modulation recording system, a high-frequency current of e.g. 50 MHz flows through the coil for magnetic field generation. The region of the magnetic field generated by the coil is biased by the magnetic element so that the magnetic field effectively acts on the magneto-optical disk. When a magnetic field is generated by the coil, the magnetic flux passes through the heat sink around the coil. The amount of magnetic flux passing through the heat sink increases as the distance between the coil and the heat sink (i.e. the radial distance between the outer circumference of the coil and the inner circumference of the heat sink is) decreases. When a large amount of magnetic flux passes through the heat sink, eddy current is likely to be generated at the heat sink due to the change of the direction of the magnetic field. Such an eddy current raises the temperature of the heat sink, deteriorating the performance (heat dissipation effect) of the heat sink.

When the distance between the coil and the heat sink is increased for preventing the generation of eddy current at the heat sink, the amount of heat dissipated by the heat sink is reduced. In such a case, a large amount of heat is unfavorably conducted to the optical lens, which may change the optical characteristics such as the refractive index of the lens. Thus, the magneto-optical disk still has room for improvement with respect to the prevention of the heat generation due to eddy current and the enhancement of the heat dissipation effect.

### SUMMARY OF THE INVENTION

It is, therefore, an object of the present invention to provide a magneto-optical head capable of preventing the heat generation due to eddy current and enhancing the heat dissipation effect. Another object of the present invention is to provide a magneto-optical disk drive provided with such a magneto-optical disk.

According to a first aspect of the present invention, there is provided a magneto-optical head comprising a lens for forming a light spot on a disk; a coil for magnetic field generation, the coil being arranged between the lens and the disk; and a heat conductor for conducting heat generated at the coil. The heat conductor is connected to a winding of the coil and extending radially outward from the coil.

Preferably, the heat conductor may be connected to the innermost turn, the outermost turn or the second innermost turn of the coil.

Preferably, the coil may include a plurality of spiral winding layers, and the heat conductor may include a plurality of heat conducting elements spaced circumferentially of the coil, each heat conducting element extending radially outward relative to a central axis of the coil. Among the heat conducting elements, any two adjacent ones are connected to different turns, except for the innermost turn, of the winding layer that is located closest to the lens.

Preferably, the above two adjacent heat conducting elements may be connected to adjacent turns of the winding layer closest to the lens. Specifically, one of the two adjacent heat conducting elements may be connected to a selected turn of the winding layer, while the other to a turn adjacent to the above-mentioned selected turn.

Preferably, the magneto-optical head of the present invention may further include a heat sink for dissipating heat generated at the coil. The heat sink is arranged around an outermost turn of the coil, and has a side surface extending radially of the coil. The heat conductor includes a portion spaced from the side surface of the heat sink by a distance sufficient for providing insulation between the heat sink and the heat conductor.

Preferably, the above-mentioned portion of the heat conductor may have a surface which is identical in configuration to the side surface of the heat sink and faces the side surface of the heat sink.

Preferably, the magneto-optical head of the present invention may further include a magnetic element arranged between the coil and the lens. The magnetic element includes a side surface extending radially of the coil. The heat conductor includes a portion spaced from the side surface of the magnetic element by a distance sufficient for providing insulation between the magnetic element and the heat conductor.

According to a second aspect of the present invention, there may be provided a magneto-optical disk drive incorporating a magneto-optical head, where the head includes: a lens for forming a light spot on a disk; a coil for magnetic field generation, the coil being arranged between the lens and the disk; and a heat conductor for conducting heat generated at the coil, the heat conductor being connected to a winding of the coil and extending radially outward from the coil.

Other features and advantages of the present invention will become clearer from the detailed description given below with reference to the accompanying drawings.

### BRIEF DESCRIPTION OF THE DRAWINGS

FIG. 1 is a sectional view illustrating a principal portion of a magneto-optical head according to a first embodiment of the present invention;

FIG. 2 is a sectional view taken along lines II-II in FIG. 1;

FIG. 3 is a sectional view taken along lines III-III in FIG. 2;

FIG. 4 is a sectional view taken along lines IV-IV in FIG. 2;

FIG. 5 is a perspective view showing the section taken along lines V-V in FIG. 2;

FIG. 6 is a plan view illustrating another embodiment of the present invention;

FIG. 7 is a plan view illustrating another embodiment of the present invention;

FIG. 8 is a sectional view taken along lines VIII-VIII in FIG. 7; and

FIG. 9 is a plan view illustrating another embodiment of the present invention.

### DETAILED DESCRIPTION OF THE PREFERRED EMBODIMENTS

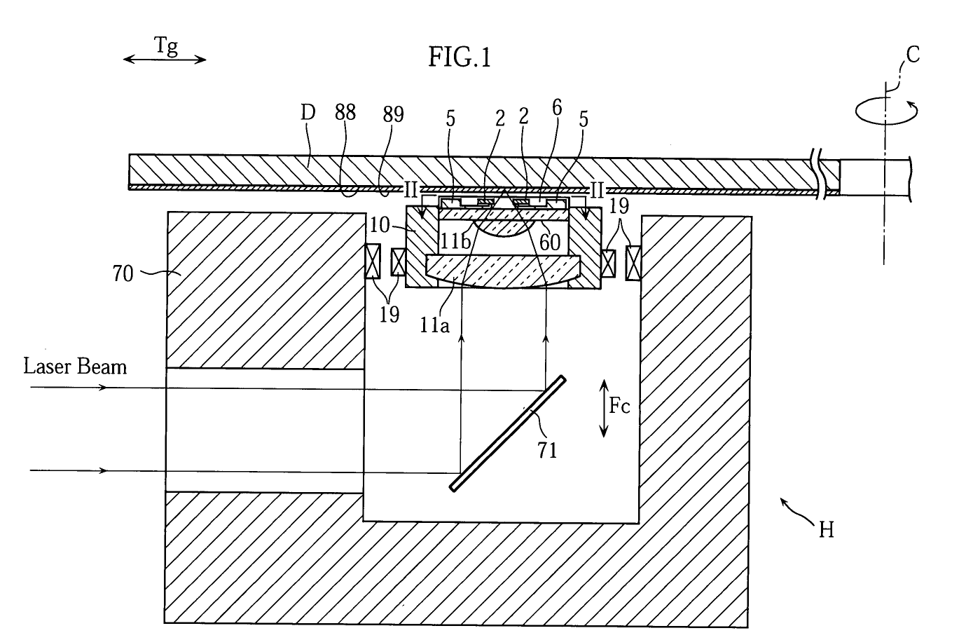

FIGS. 1 through 5 illustrate a magneto-optical head according to a first embodiment of the present invention. The magneto-optical head H is arranged in a magneto-optical disk drive, together with e.g. a spindle motor (not shown) for rotating a magneto-optical disk D at high speed about a hypothetical line C indicated in FIG. 1. The magneto-optical head H is arranged to face a recording layer 88 provided on a surface (lower surface in the figures) of the magneto-optical disk D. The recording layer 88 of the magneto-optical disk D is covered with a light-permeable insulating protective film 89. The magneto-optical head H performs, relative to the recording layer 88 of the magneto-optical disk D, laser beam application and magnetic field application in the same direction to record data in the magneto-optical disk D by magnetic field modulation. The magneto-optical head H includes a carriage 70 which carries a lens holder 10 and an upwardly reflecting mirror 71. The lens holder 10 holds a transparent substrate 60, a first objective lens 11a, and a second objective lens 11b.

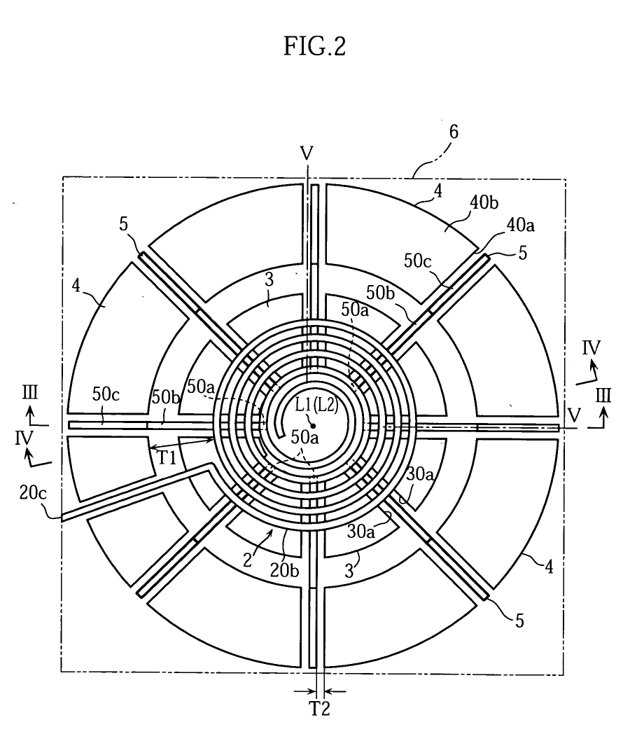

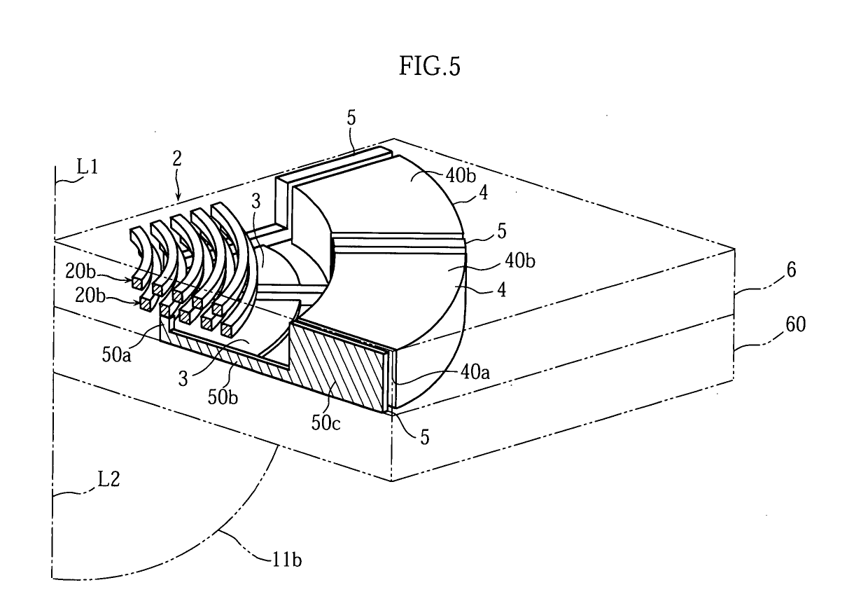

The substrate 60, as well as the second objective lens 11b, is made of glass, for example. The substrate 60 has an upper surface facing the magneto-optical disk D and provided with a coil 2 for magnetic field generation, a plurality of magnetic elements 3, a plurality of heat sinks 4, a plurality of heat conductors 5 and a dielectric film 6. The magnetic elements 3, when viewed collectively, are in the form of a generally circular plate formed with a central hollow portion for allowing laser beams to pass therethrough. The coil 2 is arranged above the magnetic elements 3. The heat sinks 4, when viewed collectively, have a generally doughnut-like configuration surrounding the coil 2 and the magnetic element 3. As shown in FIGS. 2 and 5, each of the heat conductors 5 extends radially below the coil 2 beyond the outer circumference of the coil 2. The coil 2, the magnetic elements 3, the heat sinks 4 and the heat conductors 5 are embedded in the dielectric film 6. The substrate 60 has a lower surface on which the second objective lens 11b is provided. The first objective lens 11a is arranged below the second objective lens 11b and held by the lens holder 10.

As shown in FIG. 1, the lens holder 10 is held by the carriage 70 via supporting means (not shown) which is movable in the tracking direction (radially) of the magneto-optical disk D, which is indicated by the arrow Tg. Accordingly, the lens holder 10 is movable in the tracking direction Tg. The lens holder 10 is movable also in the focusing direction indicated by the arrow Fc by a driving force of an electromagnetic driver 19, for example.

The carriage 70 is movable in the tracking direction Tg by a driving force of e.g. a voice coil motor (not shown). By moving the carriage 70 in the tracking direction Tg, the seek operation is performed to locate the lens holder 10 adjacent to an intended track. Laser beams emitted from a fixed optical unit (not shown), which may be provided with e.g. a laser diode or a collimator lens, travels through the carriage 70 to reach the upwardly reflecting mirror 71. The laser beams reflected upward by the mirror 71 are converged by the objective lenses 11a and 11b to form a laser spot on the recording layer 88. The non-illustrated optical unit is provided with a beam splitter and a photodetector. After the laser beams are reflected by the recording layer 88, the photodetector detects the reflected light.

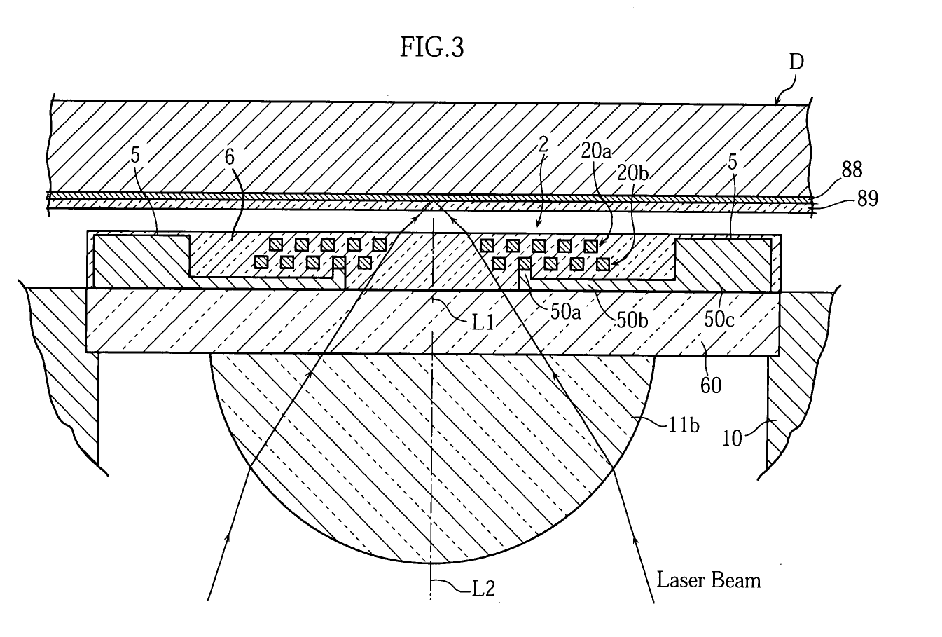

The coil 2 shown in FIGS. 2-5 may be formed by patterning a metal film such as a copper film into a predetermined configuration and may be formed by a semiconductor process, for example. The coil 2 has a central hollow portion for allowing laser beams to pass therethrough and having a central axis L1. The central axis generally corresponds to an optical axis L2 of the second objective lens 11b. The inner diameter of the coil 2, which defines the hollow portion, is about 100 μm, whereas the outer diameter of the coil 2 is about 200 μm. As clearly shown in FIGS. 3-5, the coil 2 comprises two layers of spiral windings laminated in the extending direction of the central axis L1. Hereinafter, the winding closer to the magneto-optical disk D is referred to as a first winding 20a, whereas the winding closer to the second optical lens 11b is referred to as a second winding 20b. In FIG. 2, the illustration of the first wiring 20a is omitted. Each of the first winding 20a and the second winding 20b has an outer end extending to reach a side edge of the dielectric film 6 and serving as a terminal for power supply. (Only the outer end 20c of the second winding 20b is shown in FIG. 2.) Though not illustrated, the inner ends of the first winding 20a and the second winding 20b are electrically connected to each other.

The magnetic elements 3 are made of an alloy mainly composed of nickel, iron or cobalt and have a relatively high saturation flux density. The magnetic elements 3 may be made by a semiconductor process. The magnetic elements serve to bias the magnetic field generated by the coil 2 to effectively apply the magnetic field to the magneto-optical disk D. As clearly shown in FIG. 2, the magnetic elements 3 are spaced from each other circumferentially of the coil 2, thereby having side surfaces 30a extending radially of the coil 2. Each of the magnetic elements 3 has a film thickness of several micrometers. Outer surfaces of the magnetic element 3 including the side surfaces 30a are covered with the dielectric film 6. Between the side surfaces 30a of two adjacent dielectric elements 3 extends a heat conductor 5, enclosed with the dielectric film 6. The magnetic elements 3 may be dispensed with when the magnetic field generated by the coil 2 directly acts on the magneto-optical disk D with enough strength.

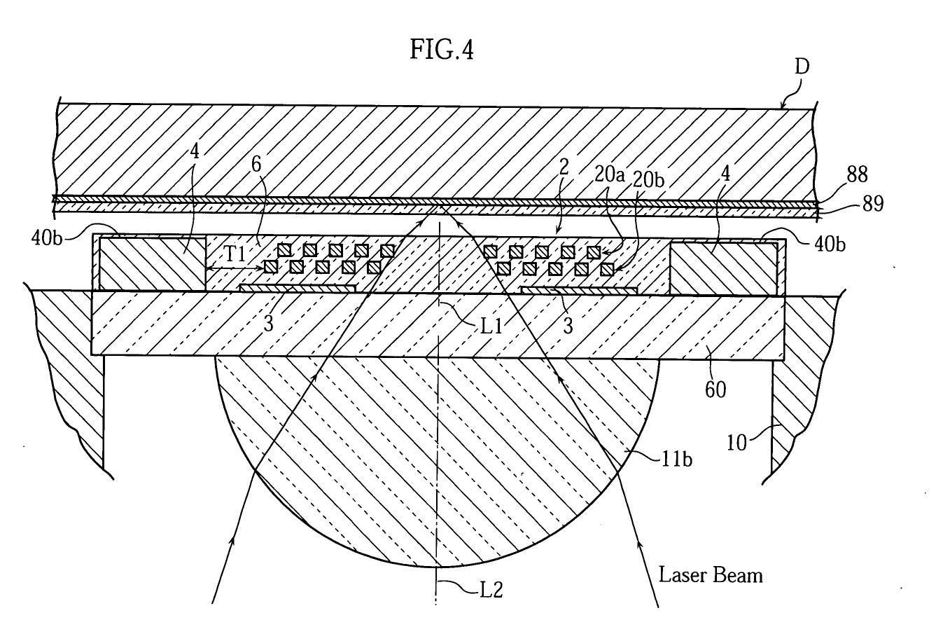

The heat sinks 4 are made of a metal such as copper, silver or gold having higher heat conductivity than the material of the dielectric film 6. The heat sinks 4 may be made by a semiconductor process. The heat sinks 4 function to dissipate the heat generated by the coil 2 and the magnetic elements 3 as well as the heat conducted through the heat conductors 5. As clearly shown in FIG. 2, the heat sinks 4 are arranged around the coil 2 and the magnetic elements 3 and spaced from each other circumferentially of the coil 2. Thus, each of the heat sinks has side surfaces 40a extending radially of the coil 2. The heat sink 4 has an upper surface 40b facing the magneto-optical disk D and located as close as possible to the magneto-optical disk D (See FIG. 4). The heat sink 4 is larger in thickness than the coil 2 and the magnetic element 3. Outer surfaces of the heat sink 4 including the side surfaces 40a and the upper surface 40b are covered with the dielectric film 6. Between the side surfaces 40a of two adjacent heat sinks 4 extends a heat conductor 5, enclosed with the dielectric film 6. As shown in FIGS. 2 and 4, the heat sink 4 is spaced from the outer circumference of the coil 2 by a distance T1. The distance T1 is so determined that the magnetic field generated by the coil 2 hardly acts on the heat sink 4 i.e. the amount of magnetic flux passing through the heat sink 4 is considerably less than that passing through the magnetic element 3. Specifically, the distance T1 may be no less than 100 μm, for example. The upper surface of the heat sink 4 may not be covered with the dielectric film.

The heat conductors 5 may be made of the same material as that of the heat sink 4, which may be copper, silver or gold, for example. The heat conductors 5 may be made by a semiconductor process. The heat conductors 5 are so arranged that the heat generated by the coil 2 be directly conducted to the heat conductors 5. As clearly shown in FIGS. 2, 3 and 5, the heat conductors 5 extend radially outward relative to the central axis L1 of the coil 2. Each of the heat conductors 5 has an inner end 50a connected to the second innermost turn of the second winding 20b of the coil 2. Each of the heat conductors 5 has an intermediate portion 50b extending between two adjacent magnetic elements 3 and below the second winding 20b without contacting the winding 20b, and has an outer end 50c extending between two adjacent heat sinks 4. The outer end 50c of the heat conductor 5 has a thickness which is larger than that of the intermediate portion 50b and generally equal to that of the heat sink 4. The outer end 50c has a pair of opposite side surfaces which face the side surface 40a of the heat sink 4 and which are identical in configuration to the side surface 40a. The outer surfaces of the heat conductor 5 are covered with the dielectric film 6 except for the portion of the inner end 50a connected to the second winding 20b. As shown in FIG. 2, the heat conductor 5 is spaced from the side surface 30a of the magnetic element 3 and the side surface 40a of the heat sink 4 by a distance T2. The distance T2 is so determined that a short circuit does not occur between the heat conductor 5 and the magnetic element 3 or the heat sink 4, and that heat is efficiently conducted from the outer end 50c of the heat conductor 5 to the heat sink 4 through the dielectric film 6. Specifically, the distance T2 may be about 10 μm, for example.

The dielectric film 6 is made of a light-permeable dielectric material such as aluminum oxide or silicon oxide and may be made by a semiconductor process. The dielectric film 6 provides insulation between the heat sinks 4 and the coil 2 or the magnetic elements 3 by intervening therebetween. Further, since the dielectric film 6 intervenes between the intermediate portion 50b of the heat conductor 5 and the coil 2 or the magnetic element 3 as well as between the outer end 50c of the heat conductor 5 and the heat sink 4, insulation is provided between the heat conductor 5 and the coil 2, the magnetic element 3 or the heat sink 4. Preferably, the dielectric film 6 has a refractive index which is generally equal to that of the substrate 60 or the second objective lens 11b.

The advantages of the magneto-optical head H will be described below.

In recording data onto the magneto-optical disk D by magnetic field modulation using the magneto-optical head H, the magneto-optical disk D is rotated, and laser beams are continuously applied to an intended track on the recording layer 88 to heat the magnetic element of the recording layer 88 to the Curie temperature. In this state, a high-frequency current of no lower than 20 MHz is caused to flow through the coil 2 to change the direction of the magnetic flux. Thus, the direction of magnetization of the magnetic element of the recording layer 88 is controlled.

The laser beams pass through the second objective lens 11b and then through the hollow portion of the coil 2 before being converged onto the recording layer 88 of the magneto-optical disk D. Specifically, the laser beams pass adjacent to the innermost turn of the second winding 20b. Since the inner end 50a of each of the heat conductors 5 is connected to the second innermost turn of the second winding 20b, the laser beams are not blocked by the tip end 50a of the heat conductor 5. Therefore, it is possible to allow the laser beams to reliably pass through the hollow portion of the coil and to generate a magnetic field of an intended magnitude without the need for increasing the size of the coil 2. Further, the incident angle of the laser beams on the hollow portion of the coil 2 can be made relatively large, so that an objective lens having a relatively large numerical aperture can be used as the second objective lens 11b. When a lens having a larger numerical aperture is used, a smaller laser spot can be formed on the recording layer 88 so that data can be recorded at high density.

When the high-frequency current flows through the coil 2, two adjacent heat conductors 5 and the heat sink 4 located therebetween would form a current path. However, since the two adjacent heat conductors 5 are connected to the same turn (second innermost turn of the second winding 20b) of the coil 2, the potential difference between the two heat conductors 5 is almost zero. Further, since the outer end 50c of the heat conductor 5 is spaced from the side surface 40a of the heat sink 4 by the distance T2 of about 10 μm, dielectric polarization is unlikely to occur between the heat conductor 5 and the heat sink 4. Therefore, the two adjacent heat conductors 5 and the heat sink 4 therebetween do not form a capacitor.

The magnetic flux generated by the coil 2 passes through the magnetic elements 3, whereby the region of the magnetic field is biased to effectively act on the magneto-optical disk D. As compared with the magnetic elements 3, only a small amount of magnetic flux passes through the heat sinks 4 and the heat conductors 5. The heat sinks 4 and the outer end 50c of each heat conductor 5, in particular, are hardly influenced by the magnetic field owing to the provision of the distance T1 from the coil 2. When the direction of the magnetic flux is changed, eddy current is generated at the magnetic elements 3, which causes a loss of the magnetic flux and raises the temperature of the magnetic element 3. However, since only a small amount of magnetic flux passes through the heat sinks 4 and the heat conductors 5, it is unlikely that eddy current is generated at the heat sinks 4 and the heat conductors 5 to heat these portions. Therefore, the temperature increase of the heat sinks 4 and the heat conductors 5 due to eddy current does not occur.

The heat generated at the coil 2 due to the high-frequency current is mostly conducted directly to the heat conductors 5 connected to the second winding 20b, while part of the heat is conducted from the outer circumference of the coil 2 to the heat sinks 4 through the dielectric film 6. The heat generated at the magnetic elements 3 due to eddy current is conducted to the heat conductors 5 through the dielectric film 6. The heat conducted to the heat conductors 5 is conducted from the end portions 50c to the side surfaces 40a of the heat sinks 4 via the dielectric film 6. Since the end portion 50c and the side surface 40a are identical in configuration and face each other, the heat conduction from the heat conductors 5 to the heat sinks 4 is performed efficiently. When the magneto-optical disk D rotates, airflow is caused between the heat sinks 4 and the magneto-optical disk D. Since the upper surface 40b of each heat sink 4 is arranged as close as possible to the magneto-optical disk D, the airflow contributes to efficient cooling of the upper surface 40b of the heat sink 4. Thus, the heat conducted to the heat sink 4 quickly travels to the upper-surface-side of the heat sink 4 for dissipation to the outside (in the air). Therefore, heat conduction to the second objective lens 11b and the substrate 60 is effectively prevented.

As noted above, heat generation due to eddy current hardly occurs at the heat sink 4, and the heat generated by the coil 2 is mostly conducted to the heat sink 4 through the heat conductor for dissipation to the outside through the upper surface 40 of the heat sink 4. Further, since the heat conductor 5 as well as the heat sink 4 functions to remove heat from around the coil 2, heat conduction to the second objective lens 11b and the substrate 60 is considerably reduced. Therefore, it is unlikely that the optical properties such as refractive index of the objective lens 11b and the substrate 60 are disadvantageously changed due to heat. Therefore, a laser spot of an appropriate size can be formed at an appropriate position on the recording layer 88 of the magneto-optical disk 88, so that the data recording density is increased.

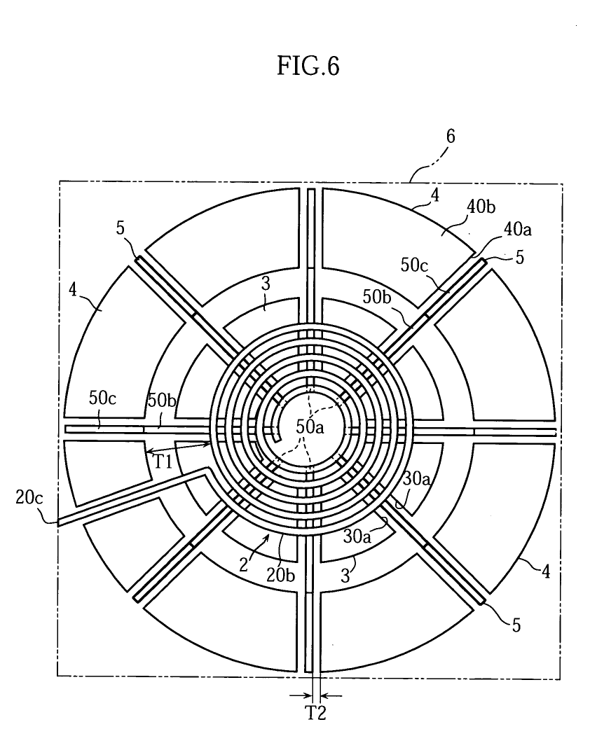

FIGS. 6-9 illustrate other embodiments of magneto-optical head according to the present invention. In these figures, the elements which are identical or similar to those of the magneto-optical disk of the foregoing embodiment are designated by the same reference sings as those used in the foregoing embodiment.

In the embodiment shown in FIG. 6, the inner end 50a of each of the heat conductors 5 is connected to the innermost turn of the second winding 20b. With this arrangement, the heat accumulated in the hollow portion of the coil 2 is conducted quickly to the heat conductors 5, which enhances the heat dissipation effect.

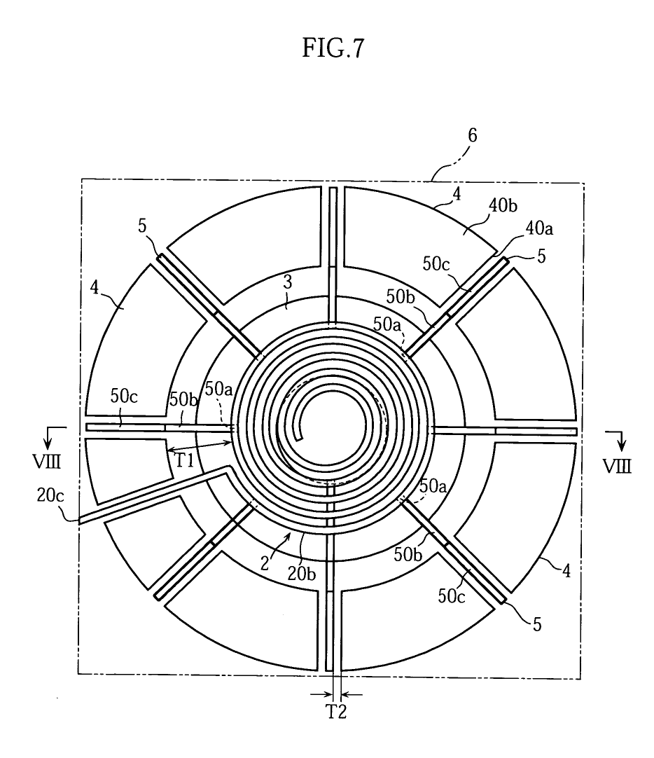

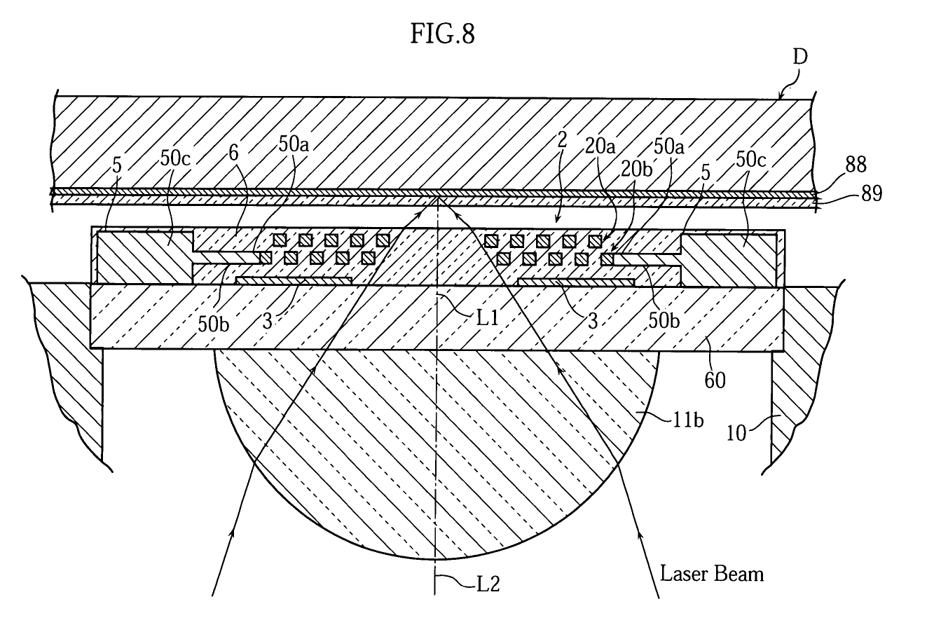

In the embodiment shown in FIGS. 7 and 8, the inner end 50a of each of the heat conductors 5 is connected to the outermost turn of the second winding 20b. As clearly shown in FIG. 8, the inner end 50a and the intermediate portion 50b extend in the same plane as the second winding 20b, and no part of the heat conductor 5 vertically overlaps the coil 2. Therefore, as shown in FIG. 7, the magnetic element 3 is provided as a one-piece plate having a ring-like shape.

At the outermost turn of each of the windings 20a and 20b, the highest electrical resistance is provided and hence the largest amount of heat is generated due to its length. Since the heat conductor 5 is connected to such an outermost turn, the large amount of heat is quickly dissipated through the heat conductor 5, whereby the heat dissipation can be performed more effectively. Moreover, when the heat conductor 5 is to be made from the same material as the coil 2, the inner end 50a and the intermediate portion 50b of the heat conductor 5 can be made simultaneously with a winding of the coil 2 (the second winding in this embodiment) in a semiconductor process, which leads to the manufacturing cost reduction and the yield enhancement.

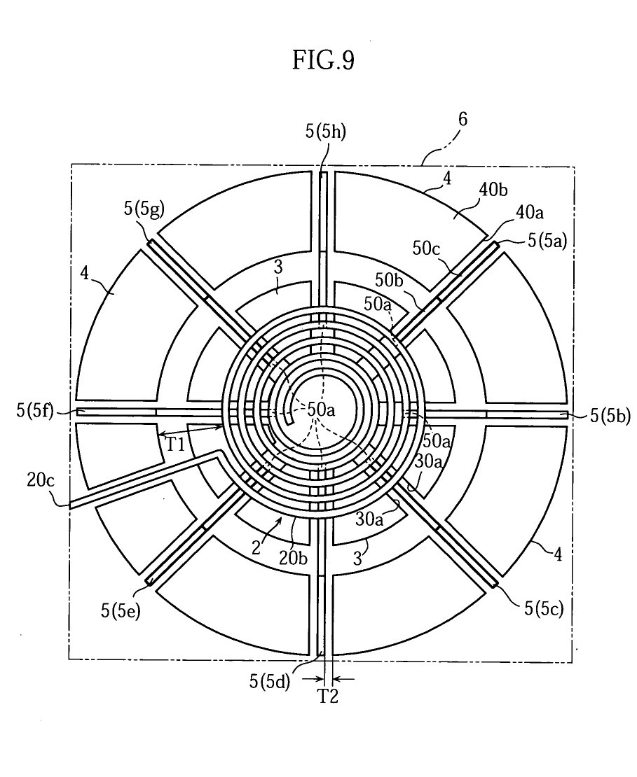

In the embodiment shown in FIG. 9, the inner ends 50a of any two adjacent heat conductors 5 are not connected to the same turn but connected to adjacent turns of the second winding 20b. Specifically, the illustrated second winding 20b has five turns. With the innermost turn designated as the first turn (supposing that the spiral extends clockwise from the center to the circumference), the inner end of the heat conductor 5a is connected to the fifth turn (i.e., the outermost turn), the inner end of the heat conductor 5b the fourth turn, the inner end of the heat conductor 5c the third turn, the inner end of the heat conductor 5d the second turn, the inner end of the heat conductor 5e the third turn, the inner end of the heat conductor 5f the second turn, the inner end of the heat conductor 5g the third turn, and the inner end of the heat conductor 5h the fourth turn. However, none of the heat conductors 5 is connected to the innermost turn (first turn) of the second winding 20b.

With this arrangement, electrical resistance corresponding to the length of no more than two continuous turns of the second winding 20b is provided between the two adjacent heat conductors 5. However, the coil portion of such a length provides only a negligible potential difference between the two adjacent conductors 5. Therefore, with this arrangement again, the two adjacent heat conductors 5 and the heat sink 4 therebetween do not form a capacitor circuit.

The present invention is not limited to the above-described embodiments, and the specific structure of each part of the magneto-optical head may be varied in many ways.

For instance, the magneto-optical head according to the present invention may be provided with a slider provided with a coil and floating slightly from the magneto-optical disk. Although the magnetic elements, the heat sinks, the heat conductors and the dielectric film can be formed relatively easily by a semiconductor process, the present invention is not limited thereto.

1. A magneto-optical head comprising:
a lens for forming a light spot on a disk;
a coil for magnetic field generation, the coil being arranged between the lens and the disk; and
a heat conductor for conducting heat generated at the coil, the heat conductor being connected to a winding of the coil and extending radially outward from the coil.

2. The magneto-optical head according to claim 1, wherein the heat conductor is connected to an innermost turn of the coil.

3. The magneto-optical head according to claim 1, wherein the heat conductor is connected to an outermost turn of the coil.

4. The magneto-optical head according to claim 1, wherein the heat conductor is connected to a second innermost turn of the coil.

5. The magneto-optical head according to claim 1, wherein the coil includes a plurality of spiral winding layers;
wherein the heat conductor comprises a plurality of heat conducting elements spaced circumferentially of the coil, each heat conducting element extending radially outward relative to a central axis of the coil; and
wherein two adjacent ones of the heat conducting elements are connected to different turns, except for an innermost turn, of one of the winding layers that is located closest to the lens.

6. The magneto-optical head according to claim 1, wherein the coil includes a plurality of spiral winding layers;
wherein the heat conductor comprises a plurality of heat conducting elements spaced circumferentially of the coil, each heat conducting element extending radially outward relative to a central axis of the coil; and
wherein two adjacent ones of the heat conducting elements are connected to adjacent turns of one of the winding layers that is located closest to the lens.

7. The magneto-optical head according to claim 1, further comprising a heat sink for dissipating heat generated at the coil, wherein the heat sink is arranged around an outermost turn of the coil, the heat sink having a side surface extending radially of the coil, the heat conductor including a portion spaced from the side surface of the heat sink by a distance sufficient for providing insulation between the heat sink and the heat conductor.

8. The magneto-optical head according to claim 7, wherein said portion of the heat conductor has a surface which is identical in configuration to the side surface of the heat sink and faces the side surface of the heat sink.

9. The magneto-optical head according to claim 1, further comprising a magnetic element arranged between the coil and the lens, wherein the magnetic element includes a side surface extending radially of the coil, the heat conductor including a portion spaced from the side surface of the magnetic element by a distance sufficient for providing insulation between the magnetic element and the heat conductor.

10. A magneto-optical disk drive comprising a magneto-optical head, the head comprising:
a lens for forming a light spot on a disk;
a coil for magnetic field generation, the coil being arranged between the lens and the disk; and
a heat conductor for conducting heat generated at the coil, the heat conductor being connected to a winding of the coil and extending radially outward from the coil.
